(19) United States
(12) Patent Application Publication
(10) Pub. No.: US 2016/0129405 A1
(43) Pub. Date: May 12, 2016

(54) Cartridge for Producing Colored Caulk

(71) Applicant: SONOCO DEVELOPMENT, INC, Hartsville, SC (US)

(72) Inventors: Subir K. Dey, Florence, SC (US); Paul Miller, Cheraw, SC (US)

(21) Appl. No.: 14/534,682

(22) Filed: Nov. 6, 2014

(51) Int. Cl. B01F 11/00; B05C 17/005

(52) U.S. Cl. CPC B01F 11/0082; B05C 17/0052

(57) ABSTRACT

A mixing apparatus for use with a caulking cartridge to produce a homogenously colored caulk is provided. The mixing apparatus comprises a mixing element affixed to a distal end of a rod and comprising a first screw lead and a second screw lead offset from each other by an angle of about 90 degrees. Each screw lead may have a helix angle of between about 3.5 degrees and about 25 degrees and, preferably, about 12.75 degrees.

### BACKGROUND OF THE INVENTION

1. Field of the Invention

This disclosure patent relates to static mixing of two fluids. More particularly, this disclosure relates to a cartridge for producing homogenously colored caulk by the static mixing of two differently colored or tinted caulks.

2. Description of the Related Art

Typical caulk is white, grey or black. Some consumers like to use caulk in other colors, including colors that match the consumer's tub, sink, countertop, windows, etc. The present disclosure is intended to provide an easy to use cartridge for producing colored caulk.

### BRIEF SUMMARY OF THE INVENTION

The disclosure relates to a mixing apparatus for use with a caulking cartridge to produce a homogenously colored caulk. The mixing apparatus may comprise a rod having a distal end and a proximal end; a mixing element affixed to the distal end of the rod; a stopper moveably affixed to the rod between the distal end and the proximal end; and a driving knob affixed to the proximal end of the rod.

The mixing element may comprise a first screw lead and a second screw lead located downstream of the first screw lead nearer the distal end. The first screw lead and the second screw lead may be in stationary alignment with each other and may be offset from each other by an angle between 0 and 180 degrees and preferably about 90 degrees.

Each screw lead may have a helix angle of between about 3.5 degrees and about 25 degrees and, preferably, about 12.75 degrees.

In another aspect of the disclosure a method of making a homogeneous colored caulk is provided. The method may comprise the steps of:

(a) Providing a caulk cartridge comprising a cylindrical tube and a plunger removably attached to a proximal end 40 of the tube;

(b) Providing a mixing apparatus according to the disclosure;

(c) Removing the plunger from the caulk cartridge;

(d) Injecting a colorant into the proximal end of the cartridge;

(e) Inserting the mixing apparatus into the cartridge tube so that the rod extends axially within the tube, the driving knob is located outside the tube and the mixing element is located within the tube;

(f) Sealing the proximal end of the cartridge tube with the stopper;

(g) Moving the mixing element in reciprocal fashion within the tube by moving the driving knob back and forth;

(h) Removing the mixing apparatus; and

(g) Resealing the cartridge by replacing the plunger in the proximal end.

The method may include the additional step of rotating the mixing element within the tube.

### BRIEF DESCRIPTION OF THE DRAWINGS

FIG. 1 is side view of a mixing apparatus according to the disclosure.

FIG. 2 is a close up side view of a portion of the mixing apparatus of FIG. 1.

FIG. 3 is a cross-sectional side view of a caulk cartridge including the mixing apparatus of FIG. 1.

FIG. 4 is a perspective view of a plunger that has been removed from the caulk cartridge of FIG. 3.

FIGS. 5A to 5F illustrate a method of using the mixing apparatus of FIG. 1.

FIG. 5A is a cross-sectional side view of a caulk cartridge just before its plunger is removed.

FIG. 5B is a perspective view of the open end of the caulk cartridge of FIG. 5A after the plunger has been removed and showing the introduction of colorant into the cartridge.

FIG. 5C is side view of a mixing apparatus according to the disclosure just before being inserted into a caulk cartridge.

FIG. 5D is a cross-sectional side view of a caulk cartridge after a mixing apparatus has been inserted into the cartridge.

FIG. 5E is a cross-sectional side view of a caulk cartridge indicating the movement of the mixing apparatus within the cartridge.

FIG. 5F is a cross-sectional side view of a caulk cartridge after a mixing apparatus has been removed from the cartridge.

### DETAILED DESCRIPTION OF THE INVENTION

While the invention may be embodied in many forms, there is shown in the drawings and will herein be described in detail one or more embodiments with the understanding that this disclosure is to be considered an exemplification of the principles of the invention and is not intended to limit the invention to the illustrated embodiments.

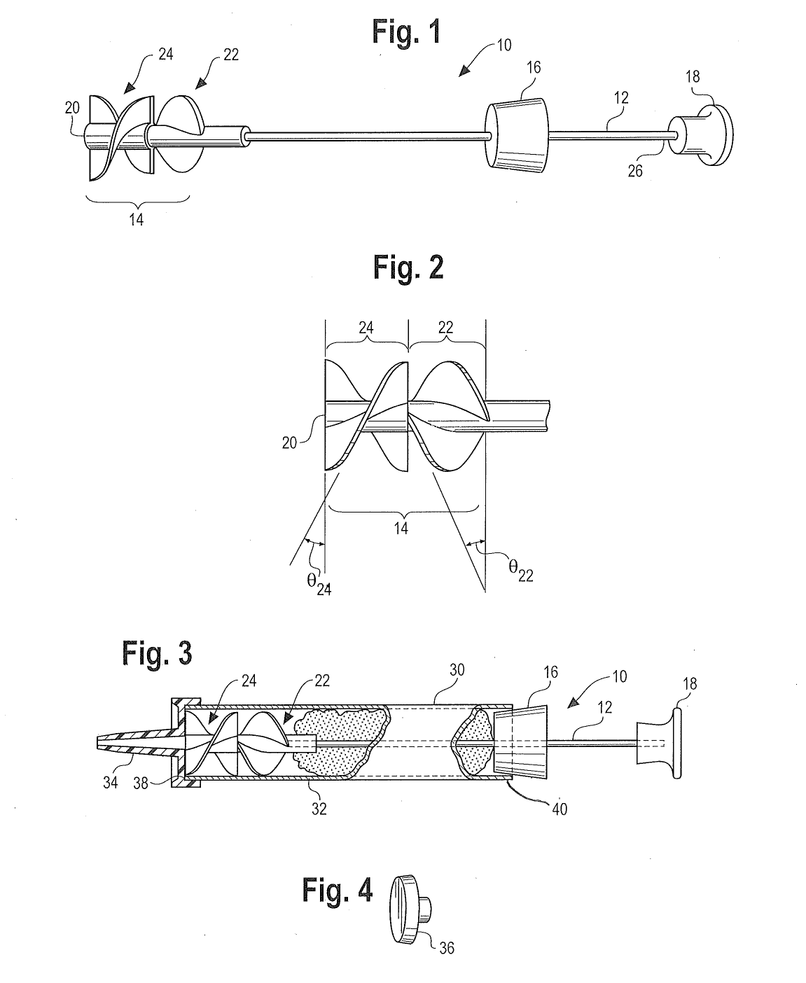

Turning to the drawings, there is shown in FIG. 1 one embodiment of a mixing apparatus 10 according to the disclosure. The mixing apparatus may be used with a caulk cartridge to produce a homogenously colored caulk from a caulk and a colorant.

The mixing apparatus 10 comprises a rod 12, a mixing element 14, a stopper 16 and a driving knob 18.

The rod 12 has a distal end 20 and a proximal end 26 to which the driving knob 18 may be attached. The rod 12 moves slidingly within a centrally located axial channel defined by the stopper 16.

FIG. 2 is a close up view of a portion of the mixing apparatus of FIG. 1 showing the mixing element 14 in more detail. The mixing element 14 is affixed to the distal end 20 of the rod 12 and comprises a first screw lead 22 and a second screw lead 24 located downstream of the first screw lead 22. The length of the mixing element 14 may be between about 0.6 inches and about 2.75 inches. The diameter of the mixing element 14 should be slightly less than the inside diameter of the caulking cartridge 30 for which it is designed to be used.

The first screw lead 22 and the second screw lead 24 are in stationary alignment with each other and may be offset from each other by an angle between 0 and 180 degrees and preferably about 90 degrees. Preferably one screw lead is left handed and the other screw lead is right handed. For example, in FIG. 2 the first screw lead 22 is right handed and the second screw lead 24 is left handed.

The helix angles (Ø₂₂, Ø₂₄) of the screw leads 22, 24 may be between about 3.5 degrees and about 25 degrees and, more preferably, about 12.75 degrees. The helix angle (Ø₂₂) of the first screw lead 22 may or may not be the same as the helix angle (Ø₂₄) of the second screw lead 24.

The driving knob 18 is attached to a proximal end 26 of the rod 12. In the illustrated embodiment the driving knob 18 is a knob-like structure, although it can be in the form of a handle or any suitable configuration

The mixing apparatus 10 is designed to be used with a caulking cartridge 30 such as that shown in FIG. 3. The cartridge 30 may be conventional in design and may comprise a cylindrical tube 32, a nozzle 34 and a plunger 36 (shown after being removed from the tube 32 in FIG. 3). The tube 32 has an inside diameter, a distal end 38 and a proximal end 40 sealed by the plunger 36. The tube 32 may have a circular cross section profile. The tube 32 may be any suitable length, such as about 8 inches.

In another aspect of the disclosure a method of making a tinted or colored caulk is provided. The method may comprise the following steps:

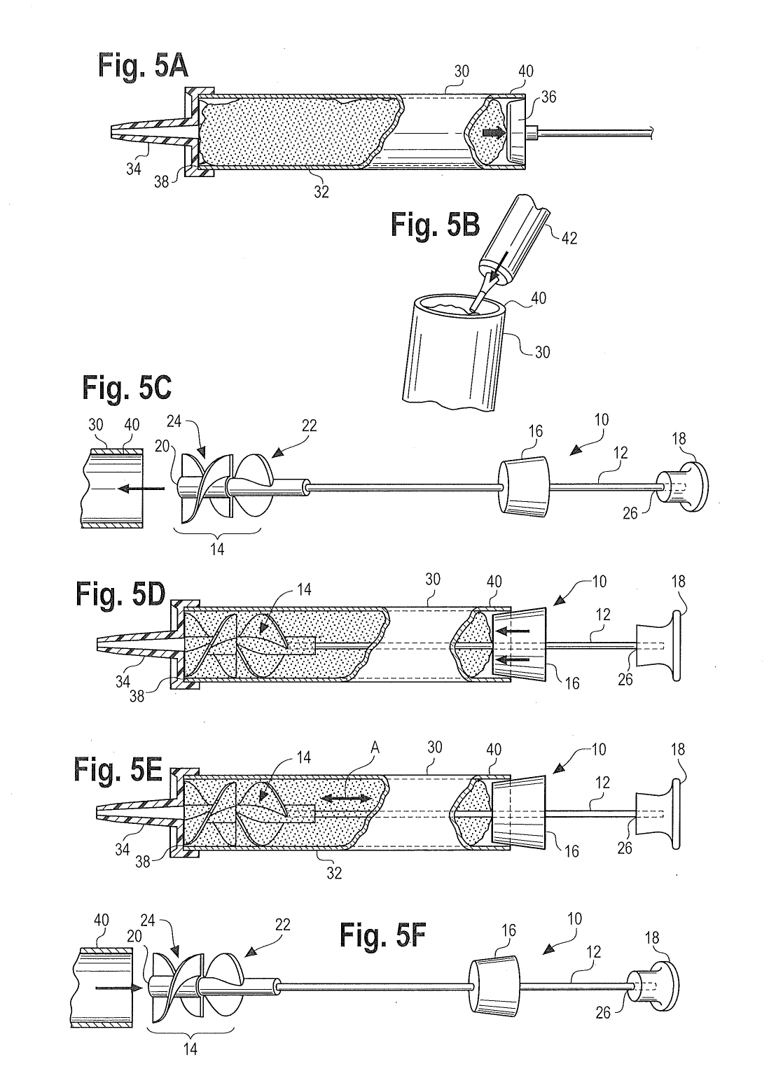

(a) Removing the plunger 36 from a caulk cartridge 30. FIG. 5A is a cross-sectional side view of a caulk cartridge 30 just before the plunger 36 has been removed.

(b) Injecting colorant into the proximal end 40 of the cartridge 30. This may require removing a small amount of caulk to make room for the colorant. FIG. 5B is a perspective view of the open end of a caulk cartridge 30 after the plunger 36 has been removed, showing the introduction of colorant into the cartridge 30 using an injector 42.

(c) Inserting a mixing apparatus 10 according to the disclosure into the cartridge tube 32. FIG. 5C is side view of a mixing apparatus 10 just before being inserted into a caulk cartridge 30.

(d) Sealing the proximal end 40 of the cartridge tube 32 with the stopper 16. FIG. 5D is a cross-sectional side view of a caulk cartridge 30 after a mixing apparatus 10 has been inserted into the cartridge 30. The stopper 16 is pushed into the proximal end 40 of the cartridge 30 and seals the proximal end 40.

(e) Moving the mixing element 14 back and forth within the tube 32 to completely mix the colorant and the caulk. The number of strokes needed to properly mix the colorant and the caulk can vary, with ten being a typical number. The user may have to rotate the mixing element 14 within the tube 32 to achieve better mixing near both ends 38 and 40. During mixing the rod 12 extends axially within the tube 32 with the driving knob 18 located outside the tube 32 and the mixing element 14 located within the tube 32. FIG. 5E is a cross-sectional side view of a caulk cartridge 30 with the back and forth movement of the mixing element 14 shown by arrow A.

(f) Removing the mixing apparatus 10 from the cartridge 30. FIG. 5F is a cross-sectional side view of a caulk cartridge 30 after a mixing apparatus 10 has been removed from the cartridge 30.

(g) Resealing the cartridge 30 by replacing the plunger 36 in the proximal end 40.

The user is now ready to apply the tinted caulk using the cartridge 30. The mixing apparatus 10 can be cleaned if necessary, and reused to tint another caulk cartridge.

It is understood that the embodiments of the disclosure described above are only particular examples which serve to illustrate the principles of the disclosure. Modifications and alternative embodiments of the disclosure are contemplated which do not depart from the scope of the disclosure as defined by the foregoing teachings and appended claims. It is intended that the claims cover all such modifications and alternative embodiments that fall within their scope.

1. A mixing apparatus for use with a caulking cartridge to produce a homogenously colored caulk, the mixing apparatus comprising:
a rod having a distal end and a proximal end;
a mixing element affixed to the distal end of the rod;
a stopper affixed to the rod between the distal end and the proximal end; and
a driving knob affixed to the proximal end of the rod; wherein
the mixing element comprises a first screw lead and a second screw lead located downstream of the first screw lead nearer the distal end, the first screw lead and the second screw lead being in stationary alignment with each other and being offset from each other by an angle between about 0 and about 180 degrees.

2. The mixing element of claim 1 wherein the first screw lead and the second screw lead are offset from each other by an angle of about 90 degrees.

3. The mixing element of claim 1 wherein each screw lead has a helix angle of between about 3.5 degrees and about 25 degrees.

4. The mixing element of claim 1 wherein each screw lead has a helix angle of about 12.75 degrees.

5. A method of making a homogeneous colored caulk comprising the steps of:
(a) Providing a caulk cartridge comprising a cylindrical tube and a plunger removably attached to a proximal end of the tube;
(b) Providing a mixing apparatus according to claim 1;
(c) Removing the plunger from the caulk cartridge;
(d) Injecting a colorant into the proximal end of the cartridge;
(e) Inserting the mixing apparatus into the cartridge tube so that the rod extends axially within the tube, the driving knob is located outside the tube and the mixing element is located within the tube;
(f) Sealing the proximal end of the cartridge tube with the stopper;
(g) Moving the mixing element in reciprocal fashion within the tube;
(h) Removing the mixing apparatus; and
(g) Resealing the cartridge by reattaching the plunger to the proximal end.

6. The method of claim 5 including the additional step of rotating the mixing element within the tube.
